(19) United States
(12) Patent Application Publication
(10) Pub. No.: US 2007/0134431 A1
(43) Pub. Date: Jun. 14, 2007

(54) Electroless plating apparatus and electroless plating method

(75) Inventors: Kenichi Hara, Nirasaki-shi (JP); Takayuki Toshima, Koshi-shi (JP); Mitsuaki Iwashita, Nirasaki-shi (JP); Takehiko Orii, Nirasaki-shi (JP)

Correspondence Address: SMITH, GAMBRELL & RUSSELL, 1850 M STREET, N.W., SUITE 800, WASHINGTON, DC, 20036, US

(73) Assignee: Tokyo Electron Limited

(21) Appl. No.: 11/606,930

(22) Filed: Dec. 1, 2006

(30) Foreign Application Priority Data
Dec. 8, 2005 (JP) JP 2005-355182

(51) Int. Cl. B05D 5/12; B05D 1/18; B05C 5/00

(52) U.S. Cl. 427/437; 427/443.1; 427/304; 427/98.4; 118/300; 118/52

(57) ABSTRACT

An electroless plating apparatus performs electroless plating on a wiring portion with a plating solution using a reducer having low reduction power. The electroless plating apparatus includes a support member with a conductive portion, which supports a substrate; a plating-solution feeding mechanism which feeds the plating solution to a top surface of the substrate supported by the support member; a metal member which is provided at the support member in such a way as to be contactable to the plating solution and dissolves into the plating solution when in contact therewith to thereby generate electrons; and an electron supply passage which supplies the electrons generated by the dissolved metal member to the wiring portion on the substrate via the conductive portion of the support member.

### BACKGROUND OF THE INVENTION

1. Field of the Invention

The present invention relates to an electroless plating apparatus and an electroless plating method which perform electroless plating on a wiring portion formed on a substrate like a semiconductor wafer with a plating solution using a reducer having low reduction power.

2. Description of the Related Art

The use of Cu (copper) for wires to be formed on a semiconductor wafer as a substrate is becoming popular in the fabrication process for semiconductor devices in order to improve the operational speed thereof. The formation of Cu wires on a substrate is generally carried out by a damascene process which forms vias and trenches to bury wires in an insulating film and bury Cu wires in the vias and trenches.

Semiconductor devices having such Cu wires are having ever-finer microfabrication patterns and ever-higher integration resulting in an increased current density. This increases current-based migration of Cu atoms, so-called electromigration, which may lead to disconnection of wires, lowering the reliability.

Accordingly, there is an attempt to improve the electromigration durability of semiconductor devices by coating a metal film, such as CoWb (cobalt tungsten boron) or COWP (cobalt tungsten phosphorus), called a cap metal, on the top surfaces of Cu wires by electroless plating.

When CoWP is used for a plating solution, the reduction action of a P (phosphorus)-based reducing agent or reducer contained in COWP is weak, mere supply of the CoWP plating solution directly to a Cu wire does not cause CoWP to be deposited on the top surface of the Cu wire. As one way to deposit CoWP on the top surface of the Cu wire, therefore, a catalyst, such as Pd (palladium), is applied to the top surface of the Cu wire (see, for example, Japanese Patent Laid-Open Publication No. H8-83796). With Pd applied to the top surface of the Cu wire, however, Pd is diffused into the Cu wire in a later heat treatment, thus increasing the wiring resistance. This lowers the operational speed of the semiconductor device.

To avoid such a situation, a metal, such as Zn (zinc) or Fe (iron), may be adhered to a Cu wire before supplying the COWP plating solution thereto, or may be made to contact the Cu wire on a electroless plating method substrate dipped in the COWP plating solution, so that the metal is dissolved into the CoWP plating solution, causing electrons to be supplied to the Cu wire. In this case, however, the metal like Zn may be taken into the semiconductor device as an impurity, or may damage the Cu wire when in contact therewith, resulting in the reduced quality of the device like a semiconductor device.

### BRIEF SUMMARY OF THE INVENTION

Accordingly, it is an object of the invention to provide an electroless plating apparatus and an electroless plating method which perform electroless plating on a wiring portion on a substrate with a plating solution using a reducer having low reduction power, without deteriorating the characteristic of a device, such as a semiconductor device, to be formed on the substrate.

According to one aspect of the invention, there is provided an electroless plating apparatus which performs electroless plating on a wiring portion with a plating solution using a reducer having low reduction power, comprising a support member with a conductive portion, which supports a substrate; a plating-solution feeding mechanism which feeds the plating solution to a top surface of the substrate supported by the support member; a metal member which is provided at the support member in such a way as to be contactable to the plating solution and dissolves into the plating solution when in contact therewith to thereby generate electrons; and an electron supply passage which supplies the electrons generated by the dissolved metal member to the wiring portion on the substrate via the conductive portion of the support member.

In the electroless plating apparatus, the electron supply passage can be structured to supply the electrons generated by the dissolved metal member to the wiring portion on the substrate via the conductive portion of the support member and the substrate. In this case, the metal member can be provided at the support member in such a way as to contact the plating solution flowing off the substrate.

In the electroless plating apparatus, the support member can be structured to support the substrate in a horizontally rotatable manner. The metal member can be provided at the support member, apart from the substrate supported by the support member. Further, The conductive portion of the support member can comprise a conductive PEEK (polyether ether ketone). The electron supply passage can be structured to selectively ground the substrate supported by the support member. Furthermore, the metal member can comprise a more basic metal than a metal used for the wiring portion on the substrate. Moreover, both of or one of the support member and the metal member metal member can be replaceable.

According to another aspect of the invention, there is provided an electroless plating method of performing electroless plating on a wiring portion with a plating solution using a reducer having low reduction power, comprising preparing a support member with a conductive portion, which supports a substrate, a metal member which is provided at the support member and dissolves into the plating solution when in contact therewith to thereby generate electrons, and an electron supply passage capable of supplying the electrons generated by the dissolved metal member to the wiring portion on the substrate via the conductive portion of the support member; supporting the substrate on the support member; feeding the plating solution onto the substrate supported by the support member such a way that the plating solution contacts the metal member; and supplying the electrons generated by the dissolved metal member to the wiring portion on the substrate via the conductive portion of the support member through the electron supply passage.

In the electroless plating method, the electron supply passage can be structured to supply the electrons generated by the dissolved metal member to the wiring portion on the substrate via the conductive portion of the support member and the substrate comprising a conductive material.

In the electroless plating method, the wiring portion on the substrate can comprise Cu (copper), and the metal member to be formed by the electroless plating comprises one of CoWP (cobalt tungsten phosphorus), CoMoP (cobalt molybdenum phosphorus), CoTaP (cobalt tantalum phosphorus), CoMnP (cobalt manganese phosphorus), and CoZrP (cobalt zirconium phosphorus).

According to the invention, the metal member which dissolves into a plating solution when in contact therewith to thereby generate electrons is provided at the support member with the conductive portion, which supports a substrate, and the electron supply passage is so structured as to be able to supply the electrons generated by the dissolved metal member to the wiring portion on the substrate via the conductive portion of the support member, the plating solution is supplied onto the substrate supported by the support member, and the electrons generated by the metal member dissolved into the plating solution to the wiring portion on the substrate through the electron supply passage. This can ensure deposition of the plating solution on the wiring portion without direct contact of the metal member with the wiring portion and a large amount of the metal in the metal member from being caught into the plating solution covering the wiring portion. It is therefore possible to start electroless plating on the wiring portion on the substrate with the plating solution that uses a reducer having low reduction power without degrading the quality of the substrate.

### BRIEF DESCRIPTION OF SEVERAL VIEWS OF THE DRAWINGS

FIG. 1 is a plan view showing the schematic configuration of an electroless plating system equipped with an electroless plating unit according to one embodiment of the present invention;

FIG. 2 is a side view showing the schematic configuration of the electroless plating system of FIG. 1 ;

FIG. 3 is a cross-sectional view showing the schematic configuration of the electroless plating system of FIG. 1;

FIG. 4 is a schematic plan view of the electroless plating unit according to the embodiment of the invention;

FIG. 5 is a schematic cross-sectional view showing the schematic configuration of the electroless plating unit of FIG. 4;

FIGS. 6A to 6C are cross-sectional views showing the essential portion of a press pin provided at an electroless plating apparatus;

FIG. 7 is a plan view showing the schematic configurations of a nozzle section provided at the electroless plating unit of FIG. 4 and a process-fluid feeding system for feeding a process fluid like a plating solution to the nozzle section;

FIG. 8 is a diagram for explaining an operational mode (moving mode) of the nozzle section provided at the electroless plating unit of FIG. 4;

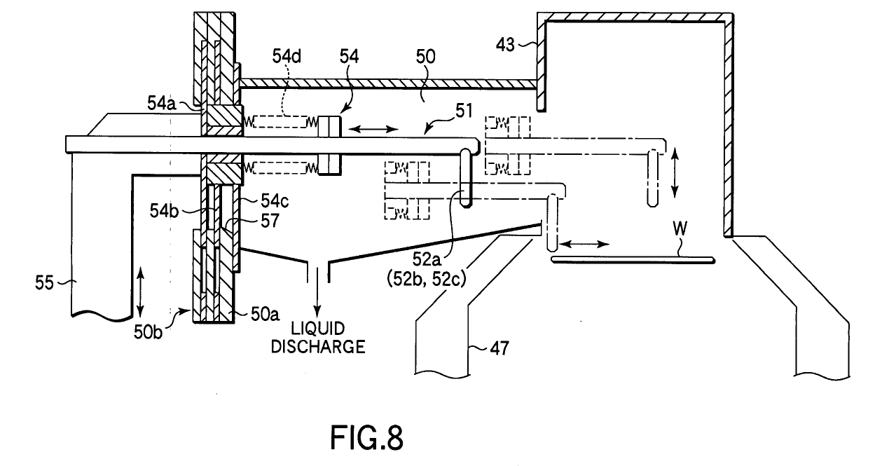

FIG. 9 is a flowchart schematically illustrating wafer process procedures in the electroless plating system of FIG. 1;

FIG. 10 is a flowchart schematically illustrating wafer process procedures in the electroless plating unit of FIG. 4;

FIG. 11 is a cross-sectional view showing a modification the electroless plating unit.

### DETAILED DESCRIPTION OF THE INVENTION

One embodiment of the present invention will be described below referring to the accompanying drawings.

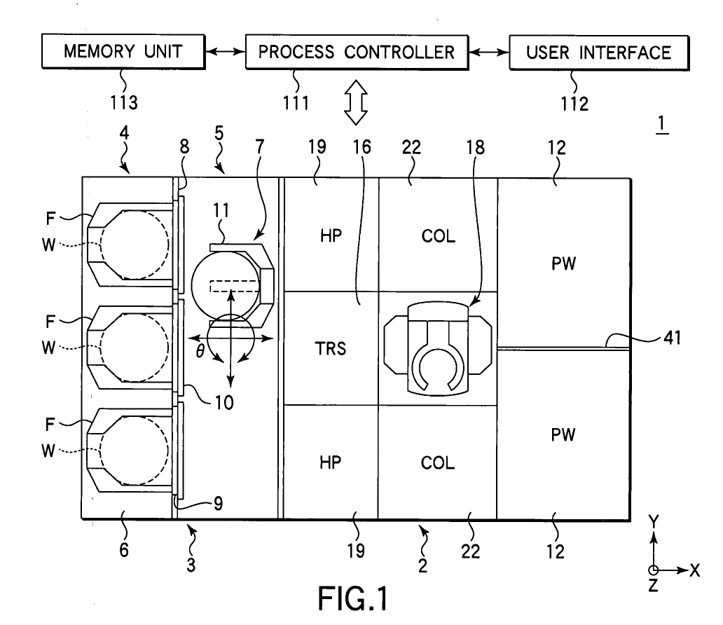

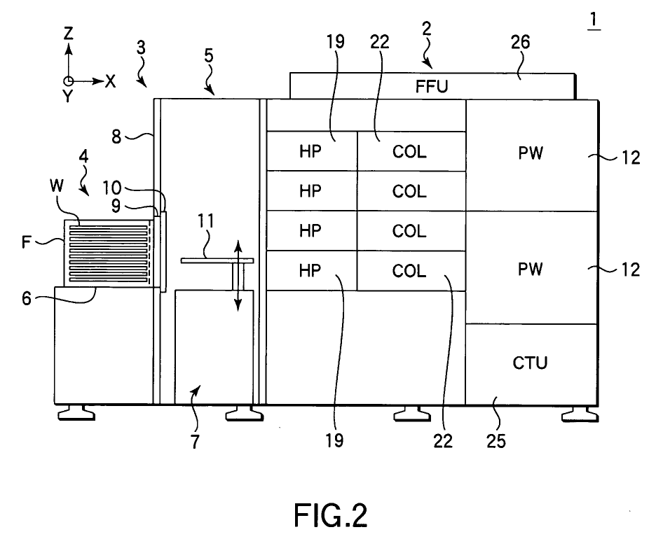

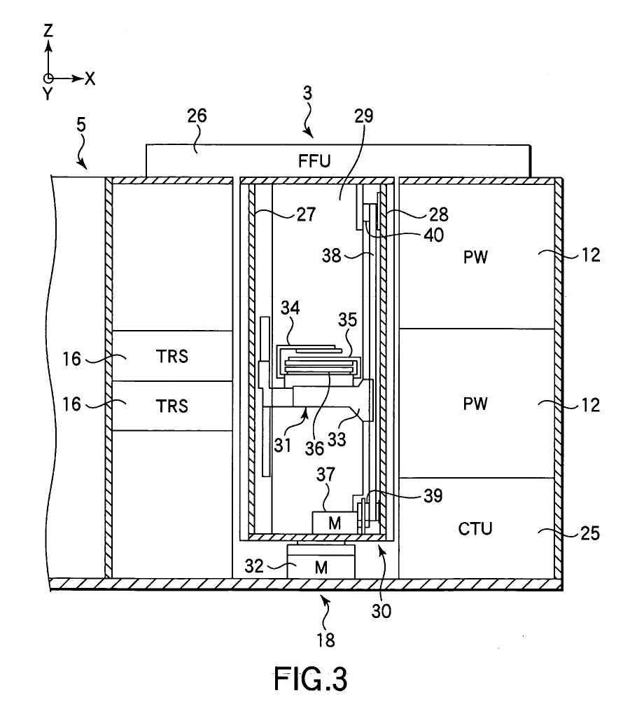

FIG. 1 is a plan view showing the schematic configuration of an electroless plating system equipped with an electroless plating unit according to one embodiment of the invention, FIG. 2 is a side view of the electroless plating system, and FIG. 3 is a cross-sectional view thereof.

An electroless plating system 1 has a processing unit 2 and a transfer in/out unit 3. The processing unit 2 performs an electroless plating process on a semiconductor wafer as a substrate to be processed, which is formed of a conductive material like silicon, (hereinafter, simply called “wafer”), and a heat treatment of the wafer before and after the electroless plating process. The transfer in/out unit 3 transfers a wafer W into and out from the processing unit 2. A wafer W in use has on its top surface a wiring portion (not shown) formed of a metal like copper (Cu). The processing unit 2 performs an electroless plating process on the wiring portion. An organic film is provided to prevent corrosion of the wiring portion.

The transfer in/out unit 3 includes an in/out port 4 and a wafer transfer section 5. The in/out port 4 is provided with a stage 6 on which a FOUP (Front Opening Unified Pod) F, a wafer retaining container, is to be mounted. The wafer transfer section 5 is provided with a wafer transfer mechanism 7 which transfers a wafer W between the FOUP F mounted on the stage 6 and the processing unit 2.

The FOUP F can retain multiple (e.g., 25) wafers W vertically stacked one on another in a horizontal state. The FOUP F has a transfer in/out port provided in one side face thereof to carry in/out wafers W, and a lid which can open and close the transfer in/out port. A plurality of slots for retaining wafers W are formed in the FOUP F in the up and down direction. Each slot retains-a single wafer W with its top surface (where the wiring portion is formed) up.

The stage 6 of the in/out port 4 is structured so that a plurality of FOUPs F, e.g., three FOUPs, are to be mounted thereon in parallel in the widthwise direction (Y direction) of the electroless plating system 1. Each FOUP F is mounted on the stage 6 with the side face having the transfer in/out port facing a boundary wall 8 between the in/out port 4 and the wafer transfer section 5. The boundary wall 8 has windows 9 formed at positions corresponding to the mount positions of the FOUPs F and shutters 10 provided on the wafer transfer section 5 side to open/close the respective windows 9.

The shutter 10 can open/close the lid provided at the FOUP F at the same time as opening/closing the window 9. It is preferable that the shutter 10 should be constructed to have an interlock to prevent the shutter 10 from operating when the FOUP F is not mounted on the stage 6 at a predetermined position. When the transfer in/out port of the FOUP F communicates with the wafer transfer section 5 with the shutter 10 opening the window 9, the wafer transfer mechanism 7 provided at the wafer transfer section 5 can access the FOUP F. A wafer check mechanism (not shown) is provided at the upper portion of the window 9 so as to be able to detect the number of, and the states of, wafers W retained in the FOUP F slot by slot. Such a wafer check mechanism can be mounted to the shutter 10.

The wafer transfer mechanism 7 provided at the wafer transfer section 5 has a transfer pick 11 to hold a wafer W, and can move in the Y direction. The transfer pick 11 can take a forward/backward motion in the lengthwise direction (X direction) of the electroless plating system 1, lift up/down motion in the height direction (Z direction) of the electroless plating system 1, and a rotational motion within the X-Y plane (θ direction). With this structure, the wafer transfer mechanism 7 can move to a position facing an arbitrary FOUP F mounted on the stage 6 to allow the transfer pick 11 to access a slot at an arbitrary height in the FOUP F, and can move to a position facing a wafer transfer unit (TRS) 16 to be discussed later provided at the processing unit 2 to allow the transfer pick 11 to access the wafer transfer unit (TRS) 16. That is, the wafer transfer mechanism 7 is structured so as to transfer a wafer W between each FOUP F and the processing unit 2.

The processing unit 2 includes a wafer transfer unit (TRS) 16, an electroless plating unit (PW) 12, a hot plate unit (HP) 19, a cooling unit (COL) 22, and a main wafer transfer mechanism 18. Wafers W are temporarily mounted on the wafer transfer unit (TRS) 16 for transfer of the wafers W to and from the wafer transfer section 5. The electroless plating unit (PW) 12 performs plating on a wafer W. The hot plate unit (HP) 19 performs a heat treatment on the wafer W before and after the plating process thereon in the electroless plating unit (PW) 12. The cooling unit (COL) 22 cools the wafer W heated by the hot plate unit (HP) 19. The main wafer transfer mechanism 18 transfers wafers W among those units. A fluid retaining unit (CTU) 25 which retains a predetermined fluid, such as a plating solution, to be fed to the electroless plating unit (PW) 12 is provided below the electroless plating unit (PW) 12 of the processing unit 2. The electroless plating apparatus according to the embodiment comprises the electroless plating unit (PW) 12 and a process-fluid feeding mechanism 60 (to be described later) provided at the fluid retaining unit (CTU) 25.

There are two wafer transfer units (TRS) 16 provided which are stacked one on the other between the main wafer transfer mechanism 18, located at nearly the center of the processing unit 2, and the wafer transfer section 5. The lower wafer transfer unit (TRS) 16 is used to mount wafers W which are transferred to the processing unit 2 from the transfer in/out unit 3, and the upper wafer transfer unit (TRS) 16 is used to mount wafers W which are transferred to the transfer in/out unit 3 from the processing unit 2.

There are four hot plate units (HP) 19 stacked one on another on either side of the wafer transfer unit (TRS) 16 in the Y direction thereof. There are four cooling units (COL) 22 stacked one on another on either side of the main wafer transfer mechanism 18 in the Y direction thereof in such a way as to be adjacent to the hot plate units (HP) 19.

There are two stages of electroless plating units (PW) 12, each stage having two electroless plating units (PW) 12 provided side by side in the Y direction, in such a way as to be adjacent to the cooling units (COL) 22 and the main wafer transfer mechanism 18. The electroless plating units (PW) 12 in parallel to each other in the Y direction have approximately the symmetrical configuration with respect to a wall surface 41 or the boundary therebetween. The details of the electroless plating unit (PW) 12 will be given later.

The main wafer transfer mechanism 18 includes a cylindrical support 30, which has vertical walls 27, 28 extending in the Z direction and a side opening 29 between the vertical walls 27, 28, and a wafer transfer body 31 provided inside the cylindrical support 30 and liftable up and down in the Z direction along the cylindrical support 30. The cylindrical support 30 is rotatable by the rotational drive force of a motor 32. The wafer transfer body 31 rotates together with the cylindrical support 30.

The wafer transfer body 31 includes a transfer platform 33, and three transfer arms 34, 35, 36 movable forward and backward along the transfer platform 33. The transfer arms 34, 35, 36 are sized so as to be passable through the side opening 29 of the cylindrical support 30. The transfer arms 34, 35, 36 can be independently moved forward and backward by a motor and a belt mechanism, which are incorporated in the transfer platform 33. As a belt 38 is driven by a motor 37, the wafer transfer body 31 moves up and down. Reference numeral “39” denotes a a drive pulley, and reference numeral “40” denotes a driven pulley.

Provided at the ceiling of the processing unit 2 is a filter fan unit (FFU) 26 which effects downflow of clean air to the individual units and the main wafer transfer mechanism 18.

The individual components of the electroless plating system 1 are so configured as to be connected to and controlled by a process controller 111 having a CPU. Connected to the process controller 111 are a user interface 112 and a storage unit 113. The user interface 112 includes a keyboard which a process manager uses to, for example, enter commands to control the individual sections or the individual units of the electroless plating system 1, and a display which presents visual display of the operational statuses of the individual sections or the individual units. Stored in the storage unit 113 are recipes recording control programs and process condition data or so for realizing individual processes to be executed by the electroless plating system 1 under the control of the process controller 111.

As an arbitrary recipe is read from the storage unit 113 and is executed by the process controller 111 in response to an instruction or the like from the user interface 112, as needed, desired processes are executed by the electroless plating system 1 under the control of the process controller 111. The recipes may be those stored in a readable storage medium, such as a CD-ROM, hard disk, a flexible disk or a non-volatile memory, or may be transferred, whenever needed, among the individual sections or the individual units of the electroless plating system 1, or from an external device, and used on line.

Next, the details of the electroless plating unit (PW) 12 will be given.

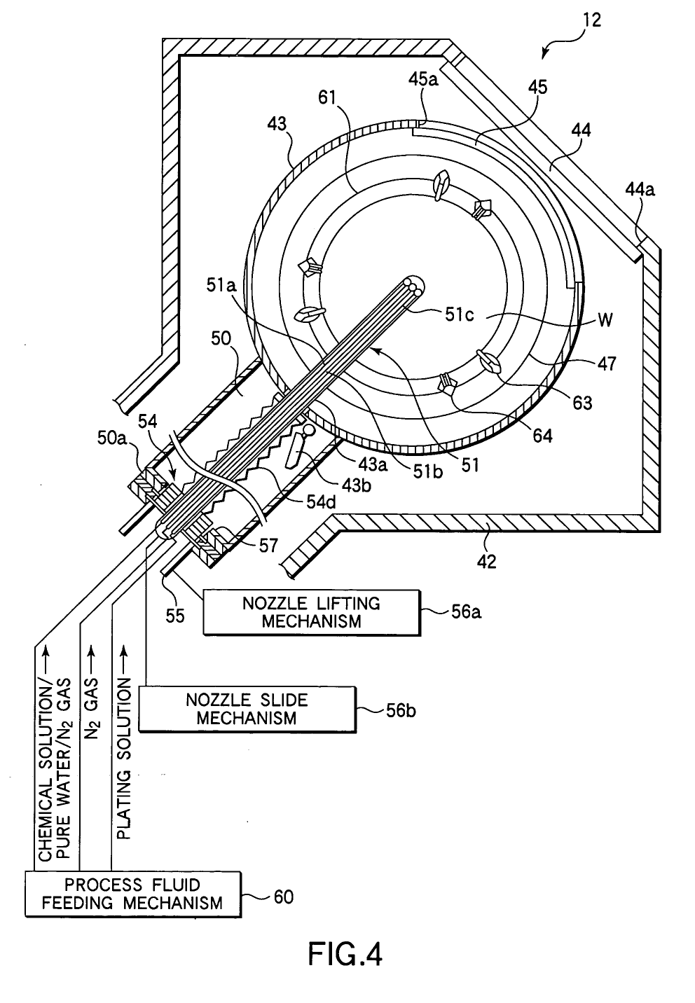

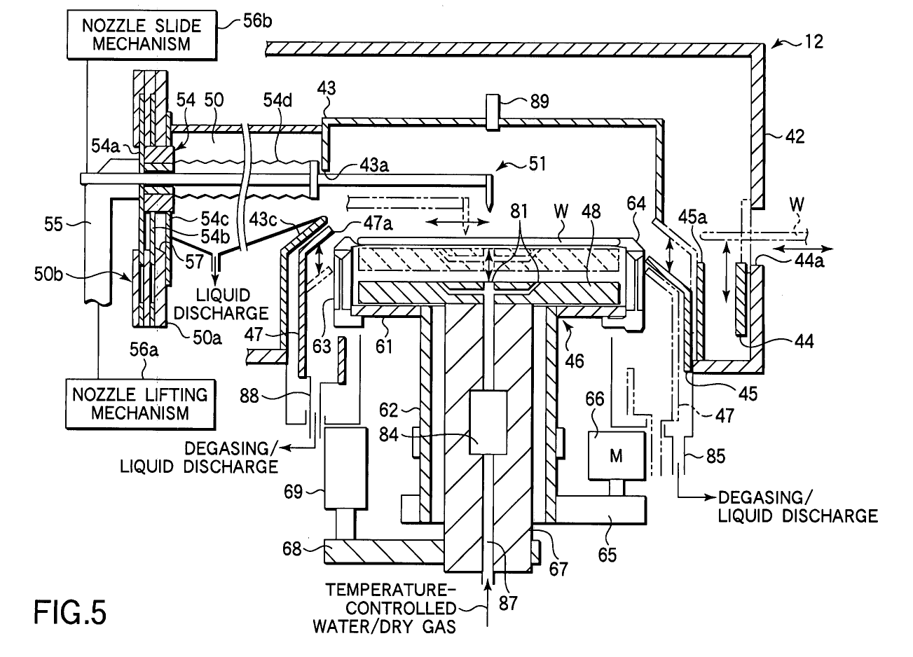

FIG. 4 is a schematic plan view of the electroless plating apparatus (electroless plating unit) 12 according to the embodiment, and FIG. 5 is a schematic cross-sectional view thereof.

The electroless plating unit (PW) 12 includes a housing 42, an outer chamber 43 provided in the housing 42, an inner cup 47 provided in the outer chamber 43, a spin chuck (support) 46 which is provided in the inner cup 47 to support a wafer W, an under plate (substrate temperature control member) 48 for controlling the temperature of a wafer W, and a nozzle section 51 which supplies a liquid, such as a plating solution or a cleaning liquid, and gas onto a wafer W supported by the spin chuck 46. Connected to the nozzle section 51 is the process-fluid feeding mechanism 60 (to be described later) which feeds the plating solution or another fluid provided in the fluid retaining unit (CTU) 25. The spin chuck 46 holds a wafer W with the top surface thereof up. The under plate 48 is provided so as to face the back side (bottom side) of the wafer W supported by the spin chuck 46, and is liftable up and down.

A window 44a is formed in one side wall of the housing 42, and is openable and closable by a first shutter 44. Each of the transfer arms 34, 35, 36 transfers a wafer W to the electroless plating unit (PW) 12 or transfers a wafer W out from the electroless plating unit (PW) 12 through the window 44a. The window 44a is kept closed by the first shutter 44 except at the time of transferring a wafer W in/out. The first shutter 44 opens and closes the window 44a from inside the housing 42.

The outer chamber 43 has a tapered portion 43c at a height where the outer chamber 43 surrounds the wafer W supported by the spin chuck 46. The outer chamber 43 has an inner wall tapered upward from a lower portion. A window 45a is formed in the tapered portion 43c in such a way as to face the window 44a of the housing 42. The window 45a is openable and closable by a second shutter 45. Each of the transfer arms 34, 35, 36 moves into and out of the outer chamber 43 through the window 44a and the window 45a to transfer a wafer W to and from the spin chuck 46. The window 45a is kept closed by the second shutter 45 except at the time of transferring a wafer W in/out. The second shutter 45 opens and closes the window 45a from inside the outer chamber 43.

A gas feeding section 89 which forms a downflow by feeding a nitrogen (N₂) gas into the outer chamber 43 is provided at the top wall of the outer chamber 43. A drain pipe 85 for degasing and liquid discharge is provided at the bottom wall of the outer chamber 43.

The inner cup 47 has a tapered portion 47a, tapered upward from a lower portion, at the upper end portion in such a way as to correspond to the tapered portion 43c of the outer chamber 43, and a drain pipe 88 at the bottom wall. The inner cup 47 is liftable up and down between a process position which is above a wafer W whose upper end is supported by the spin chuck 46 and where the tapered portion 47a surrounds the wafer W (the position indicated by the solid line in FIG. 5), and a retreat position which is below the wafer W whose upper end is supported by the spin chuck 46 (the position indicated by the phantom line in FIG. 5) by a lifting mechanism like a gas cylinder.

The inner cup 47 is held at the retreat position so as not to interfere with the forward/backward movement of each of the transfer arms 34, 35, 36 when each transfer arm 34, 35, 36 transfers a wafer W to and from the spin chuck 46, and is held at the process position when electroless plating is performed on the wafer W supported by the spin chuck 46. This prevents the plating solution supplied to the wafer W from the inner cup 47 from being splashed around. The plating solution that has dropped directly from the wafer W or the plating solution that has spattered on the wafer W and hit the inner cup 47 or the tapered portion 47a of the inner cup 47 is guided down to the drain pipe 88. A plating-solution collect line and a plating-solution dispose line (neither shown) are connected in a changeover manner to the drain pipe 88, so that the plating solution is collected through the plating-solution collect line or is disposed through the plating-solution dispose line.

The spin chuck 46 has a rotary cylinder 62 rotatable in the horizontal direction, an annular rotational plate 61 rotary cylinder 62 extending horizontally from the upper end portion of the rotary cylinder 62, mount pins 63 which are provided at the peripheral portion of the rotational plate 61 to support a wafer W mounted on the mount pins 63, and press pins 64 which are provided at the peripheral portion of the rotational plate 61 to support a wafer W mounted on the mount pins 63 by pressing the edge portion of the supported wafer W.

Transfer of a wafer W between each transfer arm 34, 35, 36 and the spin chuck 46 is executed by using the mount pins 63. To surely support a wafer W, it is preferable that the mount pins 63 should be provided at at least three locations, preferably at equal intervals.

The press pin 64 is structured so that as the portion positioned at the lower portion of the rotational plate 61 is pressed against the rotational plate 61 by a pressing mechanism (not shown), the upper end portion (distal end portion) of the press pin 64 can move outward of the rotational plate 61 and incline so as not to interfere with the transfer of a wafer W between each of the transfer arms 34, 35, 36 and the spin chuck 46. To surely support a wafer W, the mount pins 63 should likewise be provided at at least three locations, preferably at equal intervals.

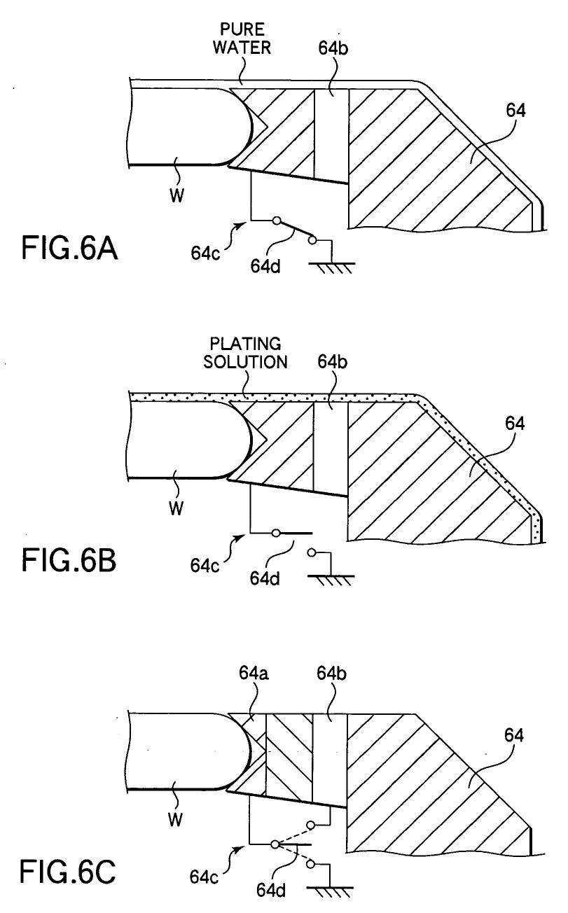

As shown in the cross-section views of FIGS. 6A to 6C, the press pin 64 is provided with a metal member 64b which dissolves into the plating solution supplied from the nozzle section 51 when in contact therewith to thereby generate electrons. The metal member 64b is formed of a more basic metal, e.g., Zn (zinc), than Cu used for the wiring portion of the wafer W. The press pin 64 is formed in such a way that its upper end face is positioned on approximately the same plane as the top surface of the supported wafer W. The metal member 64b is provided at a position apart from the wafer W supported by the press pin 64 so as to be exposed through the top end face of the press pin 64 and penetrate the press pin 64 so that the metal member 64b contacts the plating solution flowing off the wafer W. The metal member 64b is provided detachably at the press pin 64 so that it can be replaced easily. The press pin 64 may be detachably provided at the rotational plate 61 in such a way that the press pin 64 provided with the metal member 64b can be replaced.

The press pin 64 is formed of a conductive PEEK (polyether ether ketone) having excellent acid resistance and alkali resistance and a high mechanical strength, e.g., carbon PEEK. In this example, the entire press pin 64 constitutes the conductive portion. Accordingly, the press pin 64 is so structured as to serve as a part of the electron supply passage which electrically connects the supported wafer W to the metal member 64b, and supply the electrons generated by the metal member 64b dissolved into the plating solution to the wiring portion on the wafer W via the wafer W. In the embodiment, the metal member 64b, the press pin 64 and the wafer W constitute the electron supply passage for supplying electrons to the wiring portion on the wafer W. The press pin 64 is connected with a conduction line 64c which can ground the supported wafer W. The conduction line 64c has a switch portion 64d whose ON/OFF action selectively grounds the wafer W (FIG. 6A shows the wafer W being grounded).

The press pin 64 may be structured so that only an abutment portion (conductive portion) 64a with the edge portion of the wafer W is formed of conductive polyether ether ketone (PEEK), e.g., carbon PEEK. In this case, the conduction line 64c can be structured in such a way as to enable electric connection between the abutment portion 64a and the metal member 64b and the electric connection between the abutment portion 64a and the metal member 64b or grounding of the wafer W abutting on the abutment portion 64a can be selectively carried out by the switch portion 64d. In the embodiment, the metal member 64b, the conduction line 64c, the abutment portion 64a and the wafer W constitute the electron supply passage for supplying electrons to the wiring portion on the wafer W.

A belt 65 which rotates when a motor 66 is driven is put around the outer surface of the rotary cylinder 62. Accordingly, the rotary cylinder 62 rotates, causing the wafer W supported by the mount pins 63 and the press pins 64 to rotate horizontally. As the position of the barycenter of the press pin 64 is adjusted, the force of pressing a wafer W is adjusted when the wafer W rotates. For example, providing the barycenter of the press pin 64 lower than the rotational plate 61 causes the centrifugal force to act on the portion lower than the rotational plate 61 so that the upper end portion of the press pin 64 tends to move inward, thus enhancing the force to press the wafer W.

The under plate 48 is disposed above the rotational plate 61 and in the space surrounded by the mount pins 63 and the press pins 64, and is connected to a shaft 67 provided penetrating through inside the rotary cylinder 62. The shaft 67 connected with the under plate 48 is connected to a lifting mechanism 69 like an air cylinder via a horizontal plate 68 provided below the rotary cylinder 62. The lifting mechanism 69 allows the shaft 67 to be liftable up and down together with the under plate 48. A plurality of process-fluid feeding ports 81 through which a process fluid, such as pure water or a dry gas, is supplied toward the bottom side of a wafer W are provided at the top surface of the under plate 48. A process-fluid feeding path 87 along which the process fluid, such as pure water or a dry gas, flows to the process-fluid feeding ports 81 is provided in the under plate 48 and the shaft 67. A heat exchanger 84 is provided around a part of the process-fluid feeding path 87 in the shaft 67, so that the process fluid flowing in the process-fluid feeding path 87 is heated to a predetermined temperature by the heat exchanger 84 and is then supplied toward the bottom side of the wafer W from the process-fluid feeding ports 81.

When a wafer W is transferred between the spin chuck 46 and each transfer arm 34, 35, 36, the under plate 48 moves downward to come close to the rotational plate 61 so as not to hit against each transfer arm 34, 35, 36. When electroless plating is performed on the wafer W supported by the spin chuck 46, the under plate 48 moves upward to the position of the phantom line in FIG. 5 close to the wafer W to feed the temperature-controlled fluid, such as pure water, whose predetermined is controlled to a predetermined temperature, to the bottom side of the wafer W from the process-fluid feeding ports 81, thereby heating the wafer W and controlling the temperature thereof to a predetermined temperature.

The under plate 48 may be structured in such a way that the under plate 48 is fixed at a predetermined height, and the distance between the-wafer W supported by the spin chuck 46 and the under plate 48 is adjusted according to the progress of the plating process by up/down lifting of the rotary cylinder 62. That is, the under plate 48 and the wafer W supported by the spin chuck 46 have only to be movable up and down in relative to each other.

A nozzle-section storing chamber 50 is provided at one side wall of the outer chamber 43 to communicate therewith. The nozzle section 51 extends horizontally and is fitted into the nozzle-section storing chamber 50. The nozzle section 51 is liftable up and down by a nozzle lifting mechanism 56a and is slidable by a nozzle slide mechanism 56b. The nozzle slide mechanism 56b causes the nozzle section 51 to slide so that in a process mode, the distal end portion of the nozzle section 51 (the side which ejects the plating solution or the like onto a wafer W) sticks out from the nozzle-section storing chamber 50 and reaches a position above the wafer W in the outer chamber 43, while, in a temperature control mode, the distal end portion of the nozzle section 51 is retained in the nozzle-section storing chamber 50 as will be discussed later. The nozzle section 51 integrally has a chemical-solution nozzle 51a capable of feeding a chemical solution, pure water and nitrogen gas onto a wafer W, a dry nozzle 51b capable of feeding a nitrogen gas as a dry gas onto a wafer W, and a plating-solution nozzle 51c capable of feeding a plating solution onto a wafer W.

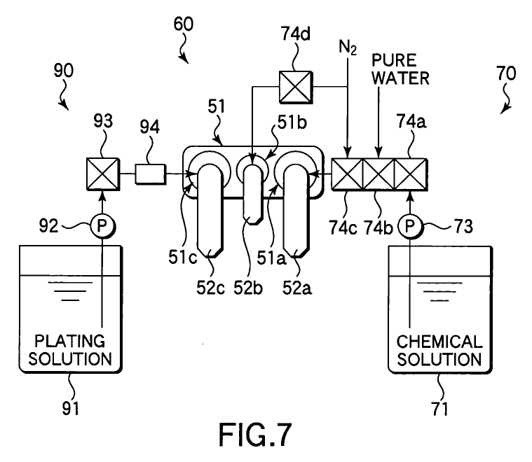

The process-fluid feeding mechanism 60 will be explained next. FIG. 7 is a diagram showing the schematic configuration of the process-fluid feeding mechanism 60.

As shown in FIG. 7, the process-fluid feeding mechanism 60 has a chemical-solution feeding mechanism 70 for feeding a chemical solution or the like to the chemical-solution nozzle 51a, and a plating-solution feeding mechanism 90 for feeding a plating solution to the plating-solution nozzle 51c.

The chemical-solution feeding mechanism 70 has a chemical-solution tank 71, a pump 73, and a valve 74a, all disposed in the fluid retaining unit (CTU) 25. The chemical-solution tank 71 heats the chemical solution to a predetermined temperature and retains the chemical solution. The pump 73 pumps up the chemical solution in the chemical-solution tank 71. The valve 74a changes over the chemical solution pumped up by the pump 73 to feed the chemical solution to the chemical-solution nozzle 51a. In addition to the chemical solution fed by the chemical-solution feeding mechanism 70, pure water and a nitrogen gas whose temperatures are controlled to predetermined temperatures are to be supplied to the chemical-solution nozzle 51a. One of the chemical solution, pure water and nitrogen gas is selectively fed by changing the opening/closing of the valves 74a, 74b, 74c. The same nitrogen-gas source can be used for the nitrogen gas to be fed to the chemical-solution nozzle 51a and the dry nozzle 51b, and feeding of the nitrogen gas to the dry nozzle 51b can be controlled by the opening/closing of a valve 74d provided separately.

The plating-solution feeding mechanism 90 has a plating-solution tank (plating-solution retaining section) 91, a pump 92, a valve 93, and a heat source 94, all disposed in the fluid retaining unit (CTU) 25. The plating-solution tank 91 retains the chemical solution. The pump 92 pumps up the plating solution in the plating-solution tank 91. The valve 93 changes over the plating solution pumped up by the pump 92 to feed the plating solution to the plating-solution nozzle 51c. The heat source 94 heats the plating solution to be fed through the valve 93 to the plating-solution nozzle 51c to a predetermined temperature. The plating-solution tank 91 retains a plating solution having a reducer having low reduction power, e.g., a plating solution comprising one of COWP, CoMoP, CoTaP, CoMnP and CoZrP. The heat source 94 comprises a heater or a a heat exchanger or the like.

The nozzle section 51 is held by an annular nozzle holding member 54 provided at a wall portion 50a constituting the outer wall of the nozzle-section storing chamber 50. The nozzle holding member 54 is so provided as to close an insertion hole 57 formed in the wall portion 50a and to be slidable in the up and down direction. The nozzle holding member 54 has three plate-like members 54a, 54b, 54c at predetermined intervals therebetween. An engage portion 50b which tightly engages with the plate-like members 54a, 54b, 54c in the thickness direction is formed at the edge portion of the insertion hole 57 of the wall portion 50a. As the tight engagement of the plate-like members 54a, 54b, 54c with the engage portion 50b makes the atmosphere in the nozzle-section storing chamber 50 hard to leak outside.

The nozzle lifting mechanism 56a is connected to the nozzle holding member 54 outside the nozzle-section storing chamber 50 via an approximately L-shaped arm 55. The nozzle lifting mechanism 56a causes the nozzle section 51 to lift up and down via the nozzle holding member 54. A cornice-like stretch portion 54d which surrounds the nozzle section 51 is provided at the nozzle holding member 54 inside the nozzle-section storing chamber 50. The nozzle section 51 is movable horizontally by the nozzle slide mechanism 56b, and the stretch portion 54d stretches and contracts according to the sliding of the nozzle section 51.

A window 43a through which the nozzle section 51 moves in and out is provided at the boundary wall portion between the nozzle-section storing chamber 50 and the outer chamber 43. The window 43a can be opened and closed by a door mechanism 43b. With the window 43a open, when the nozzle section 51 comes to a height corresponding to the window 43a by the nozzle lifting mechanism 56a, the distal-end side portion of the nozzle section 51 can move in and out of the outer chamber 43 by the nozzle slide mechanism 56b.

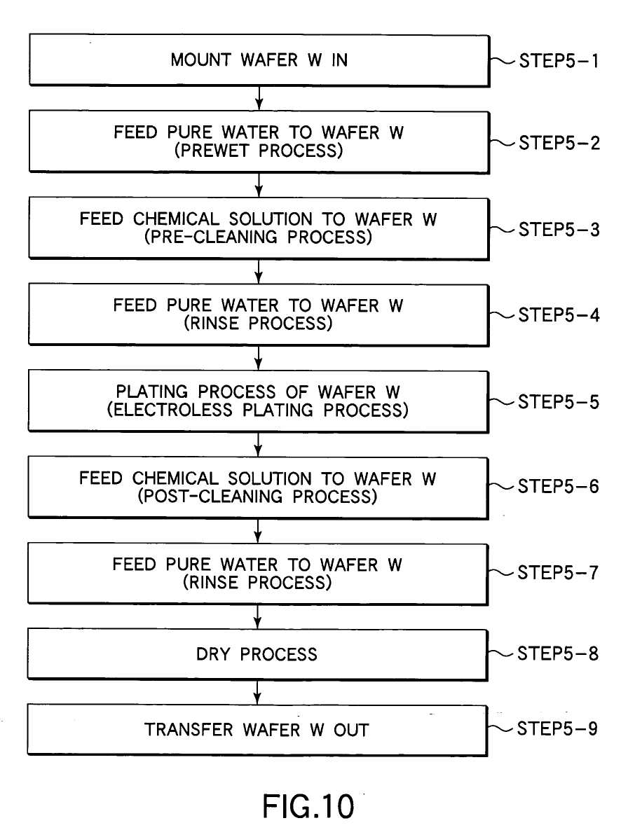

As shown in FIG. 10, the distal-end side portion of the nozzle section 51 is stored in the nozzle-section storing chamber 50 (see the solid line) with the nozzle section 51 being at a maximum retreat position, and the nozzle chip 96a, 52a is placed approximately in the center of the wafer W (see the phantom line) with the nozzle section 51 being at a maximum advance position. With the nozzle chip 96a, 52a being placed in the inner cup 47, as the nozzle section 51 is lifted up and down by the nozzle lifting mechanism 56a, the distances between the distal end of the nozzle chip 96a, 52a and the wafer W is adjusted, and as the nozzle chip 96a, 52a linearly slides between the approximate center of the wafer W and the periphery thereof by the nozzle slide mechanism 56b, the plating solution or the like can be fed to a desired radial position of the wafer W.

It is preferable that the top surface of the nozzle section 51 should be coated with a resin excellent in corrosion resistance against an acidic chemical solution and an alkaline plating solution which are used in cleaning wafers W, e.g., a fluororesin. It is also preferable that such coating is done on various components, such as the inner wall of the nozzle-section storing chamber 50, the inner wall of the outer chamber 43, and the under plate 48 disposed in the outer chamber 43. It is preferable that the nozzle-section storing chamber 50 should be provided with a cleaning mechanism to clean the distal end portion of the nozzle section 51.

Next, procedures of processing a wafer W in the electroless plating system 1 will be explained.

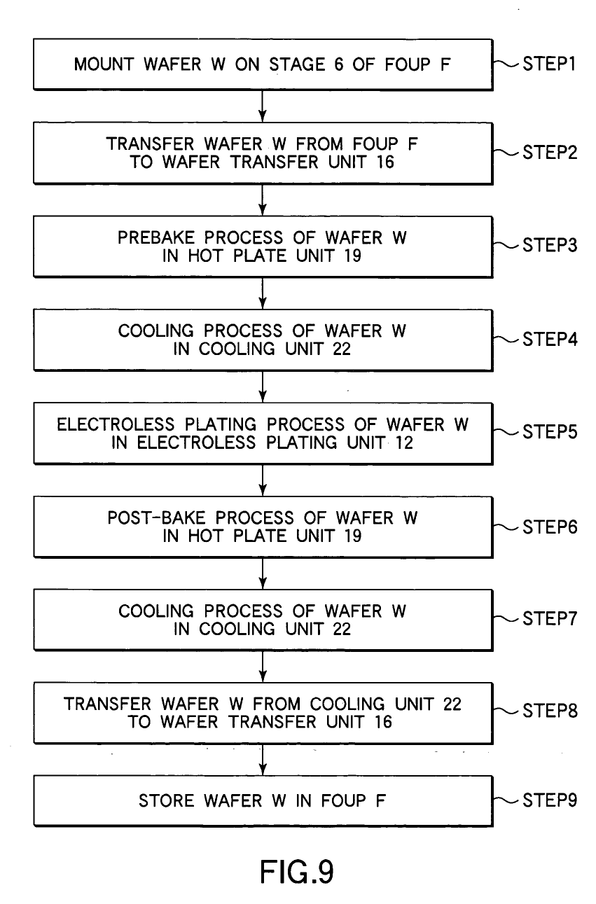

FIG. 9 is a flowchart schematically illustrating wafer process procedures in the electroless plating system 1, and FIG. 10 is a flowchart schematically illustrating wafer process procedures in the electroless plating unit 12.

First, a FOUP F retaining unprocessed wafers W is mounted on the stage 6 of the in/out port 4 at a predetermined position by a transfer robot, an operator, etc. (step 1). Next, the transfer pick 11 picks up the wafers W from the FOUP F one by one, and transfers the picked-up wafer W to one of the two wafer transfer units (TRS) 16 (step 2).

The wafer W transferred onto the wafer transfer unit (TRS) 16 by the transfer pick 11 is transferred to one of the multiple hot plate units (HP) 19 by one of the transfer arms 34 to 36 of the main wafer transfer mechanism 18. The wafer W is pre-baked in the hot plate unit (HP) 19 (step 3), resulting in sublimation of an organic film provided on the wafer W to prevent corrosion of the Cu wires. Then, the main wafer transfer mechanism 18 transfers the wafer W in the hot plate unit (HP) 19 to one of the multiple cooling units (COL) 22 where the wafer W is subjected to a cooling process (step 4).

When the cooling process of the wafer W in the cooling unit (COL) 22 is completed, the main wafer transfer mechanism 18 transfers the wafer W to one of the multiple electroless plating units (PW) 12 where the wafer W is subjected to a plating process (step 5). The detailed procedures will be described later.

When the electroless plating process of the wafer W in the electroless plating unit (PW) 12 is completed, the main wafer transfer mechanism 18 transfers the wafer W to the hot plate unit (HP) 19 where the wafer W is post-baked (step 6). This results in sublimation of an organic substance contained in the plated film coated on the wiring portion on the wafer W and enhances the adhesion between the wiring portion on the wafer W and the plated film. Then, the main wafer transfer mechanism 18 transfers the wafer W in the hot plate unit (HP) 19 to the cooling unit (COL) 22 where the wafer W is subjected to a cooling process (step 7).

When the cooling process of the wafer W in the cooling unit (COL) 22 is completed, the main wafer transfer mechanism 18 transfers the wafer W to the wafer transfer unit (TRS) 16 (step 8). Then, the transfer pick 11 picks up the wafer W placed on the wafer transfer unit (TRS) 16, and returns the wafer W into the original slot of the FOUP F where the wafer W has been originally retained (step 9).

A detailed description will now be given of the procedures of the plating process of the wafer W in the electroless plating unit (PW) 12 in the step 5.

First, the wafer W transferred from the cooling unit (COL) 22 by the main wafer transfer mechanism 18 is placed into the electroless plating unit (PW) 12 (step 5-1). At this time, the first shutter 44 provided at the housing 42 and the second shutter 45 provided at the outer chamber 43 are opened to open the windows 44a and 45a, the inner cup 47 is moved down to the retreat position, and the under plate 48 is moved down to a position close to the rotational plate 61. In this state, one of the transfer arms 34, 35, 36 of the main wafer transfer mechanism 18 is moved into the outer chamber 43 to transfer the wafer W to the mount pins 63 provided at the spin chuck 46, and the wafer W is supported by the press pins 64. Thereafter, the transfer arm is moved out of the outer chamber 43, and the first shutter 44 and the second shutter 45 close the windows 44a and 45a.

Next, the window 43a is opened, and the distal-end side portion of the nozzle section 51 enters the outer chamber 43 to be positioned over the wafer W. Then, pure water is supplied onto the wafer W by the chemical-solution nozzle 51a to perform a pre-wet process of the wafer W (step 5-2). The pre-wet process of the wafer W is carried out by moving the nozzle section 51 in such a way as to, for example, form a paddle of a process liquid or pure water in this case on the wafer W while the wafer W is stationary or rotating at a gentle rotational speed, and linearly scan the nozzle chip 52a of the chemical-solution nozzle 51a between the center portion of the wafer W and the peripheral portion thereof while ejecting a predetermined amount of pure water to the wafer W from the nozzle section 51, the chemical-solution nozzle 51a in this case, with the wafer W held over a predetermined time or rotating at a given rotational speed. A cleaning process, a rinse process, an electroless plating process and a dry process of the wafer W to be described later can likewise be carried out by such a method. The number of rotations of the wafer W is adequately selected according to the process conditions of the cleaning process, the electroless plating process and the like.

When the pre-wet process of the wafer W is finished and the pure water adhered to the wafer W is spun off to some degree by the rotation of the spin chuck 46, a chemical solution from the chemical-solution tank 71 is fed onto the wafer W by the nozzle section 51 to perform a pre-cleaning process of the wafer W (step 5-3). This removes the acidic film adhered to the wiring portion of the wafer W. The chemical solution spun off or dropped off the wafer W is discharged from the drain pipe 85 to be used again or disposed.

The chemical solution to be used in the pre-cleaning process for the wafer W is preferably a malate solution or malonate solution with a concentration of 1 to 80 g/l for the following reason. After the cleaning process was carried out with various acidic chemical solutions, the incubation time (the time of initiating plating of a wafer W after impregnation of the wafer W in the plating solution) was measured. The measurements showed that the use of a malate solution or a malonate solution for a chemical solution made the incubation time shorter as compared with the case of using other acidic solutions (see Table 1).

TABLE 1

| Pre-cleaning Solution | Incubation Time (sec) |
|---|---|
| malate (pH 2) | 1.1 |
| malate (pH 5) | 1.2 |
| malate (pH 7) | 3.2 |
| malonate (pH 7) | 1.1 |
| oxalate (pH 1) | 3.4 |
| glyoxylate (pH 1) | 2.2 |
| ascorbate (pH 1) | 1.9 |
| methanoc acid (pH 1) | 2.1 |
| citrate (pH 1) | 2.1 |
| 5% sulfate (pH 1) | 1.8 |

When the pre-cleaning process of the wafer W is finished, pure water is supplied onto the wafer W by the chemical-solution nozzle 51a to perform a rinse process of the wafer W (step 5-4). At the time of performing the rinse process of the wafer W, the switch portion 64d of the conduction line 64c provided at the press pin 64 is changed over to ground the wafer W (see FIG. 6A). Therefore, the supply of pure water allows static electricity generated on the wafer W to escape, thus preventing electrostatic breakdown of various films, such as the low-k film provided on the wafer W. During or after the rinse process of the wafer W, the under plate 48 moves upward to come close to the wafer W, and pure water heated to a predetermined temperature is supplied to the wafer from the process-fluid feeding ports 81 to heat the wafer W to the predetermined temperature.

When the rinse process of the wafer W is finished and the pure water adhered to the wafer W is spun off to some degree by the rotation of the spin chuck 46, the inner cup 47 moves up to the process position. Then, the switch portion 64d of the conduction line 64c provided at the press pin 64 is changed over to enable the electric connection between the wafer W and the metal member 64b (see FIG. 6B), and the plating solution from the plating-solution tank 91 is supplied from the plating-solution nozzle 51c onto the wafer W, heated to the predetermined temperature, via the heat source 94 to initiate the electroless plating process of the wafer W (step 5-5). In effecting the electroless plating process, it is desirable that the temperature of the wafer W should coincide with the temperature of the plating solution supplied onto the wafer W. This is because if those temperatures differ from each other, the plating growth speed may vary and the planar uniformity may be lost.

How to perform the electroless plating process on a wafer W will be described specifically. First, the plating solution supplied onto the wafer W from the plating-solution nozzle 51c is let to flow off the wafer W and contact the metal member 64b provided at the press pin 64. The contact of the plating solution with the metal member 64b can be carried out by using the centrifugal force generated by the rotation of the wafer W by the spin chuck 46. The plating solution that has been spun off the wafer W or flowed off the wafer W is discharged from the drain pipe 88 to be used again or disposed. The metal member 64b when in contact with the plating solution dissolves into the plating solution, thus generating electrons (e.g., Zn→Zn²⁺+2e⁻). Because the metal member 64b dissolves into the plating solution which has flowed off the wafer W and never returns onto the wafer W, the metal member 64b is hardly caught in the plating solution covering the wiring portion. The electrons are supplied from the metal member 64b to the wiring portion on the wafer W, passing through the press pin 64 and the wafer W. That is, as transfer of electrons can be carried out with the metal member 64b not in contact with the wiring portion on the wafer W, the wiring portion will not be damaged by the metal member 64b. As a result, the potential of the wiring portion rises to become unbalanced with the potential of the interface between the wiring portion on the wafer W and the plating solution. This promotes the deposition of a metal film on the wiring portion caused by the plating solution, so that plating is initiated. It is therefore possible to surely cover the wiring portion of Cu with the plating solution containing a reducer having low reduction power without degrading the quality of the wafer W or the semiconductor device.

When only the abutment portion 64a of the press pin 64 which abuts with the edge portion of the wafer W is formed of conductive PEEK, as shown in FIG. 6C, the switch portion 64d of the conduction line 64c is changed over to electrically connect the abutment portion 64a to the metal member 64b in executing the electroless plating process. Accordingly, the electrons generated by the metal member 64b dissolved into the plating solution are supplied from the metal member 64b to the wiring portion on the wafer W, passing through the conduction line 64c, the abutment portion 64a and the wafer W, thus promoting the deposition of a metal film on the wiring portion caused by the plating solution.

When the electroless plating process of the wafer W is finished, the supply of heated pure water from the process-fluid feeding ports 81 of the under plate 48 is stopped and the inner cup 47 is moved down to the retreat position. Then, the chemical-solution nozzle 51a feeds the chemical solution from the chemical-solution tank 71 onto the wafer W to perform a post-cleaning process of the wafer W (step 5-6). This eliminates the residue of the plating solution adhered on the wafer W, thus preventing contamination. The chemical solution spun off or dropped off the wafer W is discharged from the drain pipe 85 to be used again or disposed.

When the post-cleaning process of the wafer W is finished, the switch portion 64d of the conduction line 64c provided at the press pin 64 is changed over to ground the wafer W (see FIG. 6A), and the chemical-solution nozzle 51a feeds pure water onto the wafer W to perform a rinse process of the wafer W (step 5-7). At the time of the rinse process, the chemical solution remaining in the chemical-solution nozzle 51a is ejected first and the internal cleaning of the chemical-solution nozzle 51a is executed at the same time.

In the rinse process, procedures of temporarily stopping feeding pure water from the chemical-solution nozzle 51a and rotating the wafer W at a high rotational speed to remove pure water off the wafer W once, then setting the rotational speed of the wafer W back and feeding pure water onto the wafer W again may be repeated.

At the time of or after the rinse process, the under plate 48 moves downward away from the wafer W. When the rinse process is completely finished, the wafer W is rotated by the spin chuck 46 and a nitrogen gas is fed onto the wafer W from the chemical-solution nozzle 51a to perform a dry process of the wafer W (step 5-8).

At the time of the dry process, the nitrogen gas is fed to the bottom side of the wafer W from the process-fluid feeding ports 81 of the under plate 48, and the under plate 48 moves upward again to come close to the wafer W and dry the bottom side of the wafer W. The dry process of the wafer W can be carried out by, for example, rotating the wafer W at a low rotational speed for a predetermined time, then rotating the wafer W at a high rotational speed for a predetermined time.

When the dry process of the wafer W is finished, the wafer W is transferred out of the electroless plating unit (PW) 12 (step 5-9). Specifically, first, the nozzle section 51 is moved to a predetermined height by the nozzle lifting mechanism 56a as needed, the distal end portion of the nozzle section 51 is stored in the nozzle-section storing chamber 50 by the nozzle slide mechanism 56b, and the window 43a is closed. Next, the under plate 48 is moved downward away from the wafer W in which state the wafer W is relieved of the pressure of the press pins 64 and is supported only by the mount pins 63. Next, the windows 44a and 45a are opened, and one of the transfer arms 34, 35, 36 enters the outer chamber 43 to receive the wafer W supported by the mount pins 63. Then, the transfer arm having received the wafer W leaves the electroless plating unit (PW) 12, and the windows 44a and 45a are closed.

In the electroless plating system 1, the pressure inside the transfer chamber where the wafer transfer unit (TRS) 16 and the main wafer transfer mechanism 18 are provided is kept higher than the pressure in the electroless plating unit (PW) 12 so that the atmosphere in the electroless plating unit (PW) 12 does not flow into the transfer chamber. Further, the pressures inside the hot plate unit (HP) 19 and the cooling unit (COL) 22 are kept higher than the pressure in the transfer chamber, the atmosphere in the transfer chamber does not flow into the hot plate unit (HP) 19 and the cooling unit (COL) 22. This prevents particles or so from entering the transfer chamber from the electroless plating unit (PW) 12, and prevents particles or so from entering the hot plate unit (HP) 19 and the cooling unit (COL) 22 from the transfer chamber. Therefore, particles or so are prevented from entering the hot plate unit (HP) 19 and the cooling unit (COL) 22 from the electroless plating unit (PW) 12. This reliably prevents oxidation and contamination on the top surface of the wafer W cleaned by the heating process, and provides an excellent plated film on the wiring portion on the wafer W. The pressure in, for example, the clean room where the electroless plating system 1 is sited is kept higher than the pressure in the transfer chamber, so that the atmosphere in the transfer chamber does not flow into the clean room.

Next, a modification of the electroless plating unit (PW) will be explained.

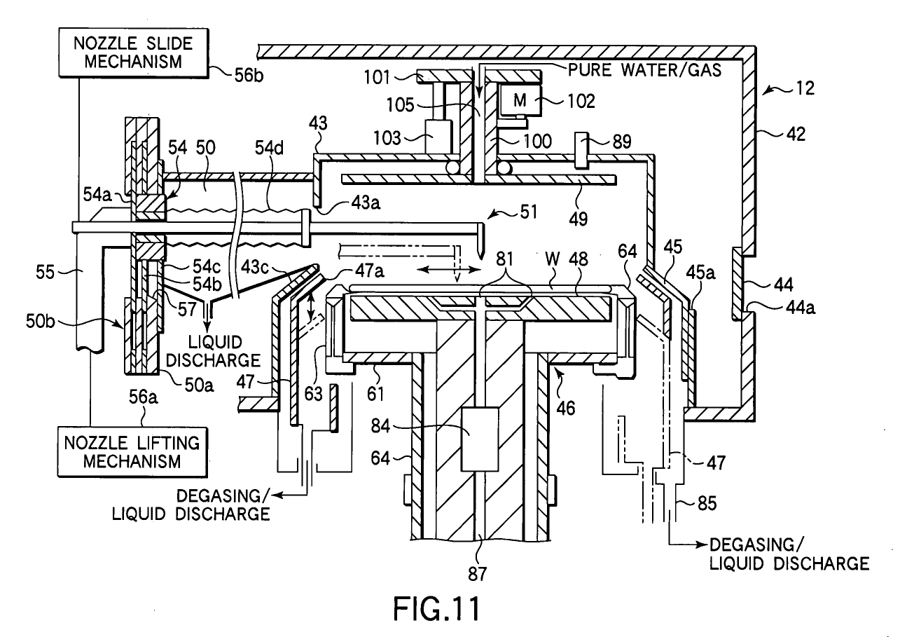

FIG. 11 is a cross-sectional view showing a modification of the electroless plating unit (PW). An electroless plating unit (PW) 12′ shown in FIG. 11 is configured to have, in the outer chamber 43, a top plate 49 facing above the wafer W supported by the spin chuck 46. The top plate 49 is connected to the lower end of a pivot 100 and is rotatable by a motor 102. The pivot 100 is rotatably supported on the bottom side of a horizontal plate 101, which is liftable up and down by a lifting mechanism 103, such as an air cylinder, secured to the top wall of the outer chamber 43. A pure-water feeding hole 105 through which pure water can be fed onto the wafer W supported by the spin chuck 46 is provided in the pivot 100 and the top plate 49.

At the time the wafer W is transferred between the spin chuck 46 and one of the transfer arms 34, 35, 36, the top plate 49 is held at a position close to the top wall of the outer chamber 43 so as not to hit against the transfer arm 34, 35, 36. At the time of performing the cleaning process or the electroless plating process on the wafer W, the chemical-solution nozzle 51a or the plating-solution nozzle 51c feeds the chemical solution or the plating solution onto the wafer W to form a paddle thereon, then the top plate 49 is moved downward to contact the paddle, thereby forming a chemical solution layer or a plating solution layer between the top of the wafer W and the top plate 49. At this time, it is preferable to incorporate a heater (not shown) in the top plate 49 so that the temperature of the chemical solution or the plating solution does not drop. The rinse process of the wafer W can be carried out by, for example, rotating the top plate 49 and the wafer W at a predetermined rotational speed while feeding pure water to the wafer W from the pure-water feeding hole 105.

The invention is not limited to the embodiment but can be modified in various other forms. For example, the metal member which dissolves into a plating solution to generate electrons may be provided at the abutment portion of the support member which supports a substrate with respect to the substrate. In this case, the metal member also serves as the conductive portion. The materials for the substrate, the wiring portion on the substrate, the plating solution, the support member and the metal member are not limited to those of the embodiment described above, and other materials may be used as well. Further, the substrate is not limited to a semiconductor wafer, and may be another type of substrate, such as a glass substrate for LCD or a ceramic substrate.

What is claimed is:

1. An electroless plating apparatus which performs electroless plating on a wiring portion with a plating solution using a reducer having low reduction power, comprising:
a support member with a conductive portion, which supports a substrate;
a plating-solution feeding mechanism which feeds said plating solution to a top surface of said substrate supported by said support member;
a metal member which is provided at said support member in such a way as to be contactable to said plating solution and dissolves into said plating solution when in contact therewith to thereby generate electrons; and
an electron supply passage which supplies said electrons generated by said dissolved metal member to said wiring portion on said substrate via said conductive portion of said support member.

2. The electroless plating apparatus according to claim 1, wherein said electron supply passage is structured to supply said electrons generated by said dissolved metal member to said wiring portion on said substrate via said conductive portion of said support member and said substrate.

3. The electroless plating apparatus according to claim 2, wherein said metal member is provided at said support member in such a way as to contact said plating solution flowing off said substrate.

4. The electroless plating apparatus according to claim 1, wherein said support member supports said substrate in a horizontally rotatable manner.

5. The electroless plating apparatus according to claim 1, wherein said metal member is provided at said support member, apart from said substrate supported by said support member.

6. The electroless plating apparatus according to claim 1, wherein said conductive portion of said support member comprises a conductive PEEK (polyether ether ketone).

7. The electroless plating apparatus according to claim 1, wherein said electron supply passage is structured to selectively ground said substrate supported by said support member.

8. The electroless plating apparatus according to claim 1, wherein said metal member comprises a more basic metal than a metal used for said wiring portion on said substrate.

9. The electroless plating apparatus according to claim 1, wherein both of or one of said support member and said metal member metal member is replaceable.

10. An electroless plating method of performing electroless plating on a wiring portion with a plating solution using a reducer having low reduction power, comprising:
preparing a support member with a conductive portion, which supports a substrate, a metal member which is provided at said support member and dissolves into said plating solution when in contact therewith to thereby generate electrons, and an electron supply passage capable of supplying said electrons generated by said dissolved metal member to said wiring portion on said substrate via said conductive portion of said support member;
supporting said substrate on said support member;
feeding said plating solution onto said substrate supported by said support member such a way that said plating solution contacts said metal member; and
supplying said electrons generated by said dissolved metal member to said wiring portion on said substrate via said conductive portion of said support member through said electron supply passage.

11. The electroless plating method according to claim 10, wherein said electron supply passage is structured to supply said electrons generated by said dissolved metal member to said wiring portion on said substrate via said conductive portion of said support member and said substrate comprising a conductive material.

12. The electroless plating method according to claim 10, wherein said wiring portion on said substrate comprises Cu (copper), and said metal member to be formed by said electroless plating comprises one of COWP (cobalt tungsten phosphorus), CoMoP (cobalt molybdenum phosphorus), CoTaP (cobalt tantalum phosphorus), CoMnP (cobalt manganese phosphorus), and CoZrP (cobalt zirconium phosphorus).
